(19) United States
(12) Patent Application Publication
(10) Pub. No.: US 2026/0044037 A1
(43) Pub. Date: Feb. 12, 2026

(54) LIQUID CRYSTAL DEVICE FOR A TIMEPIECE

(71) Applicant: The Swatch Group Research and Development Ltd, Marin (CH)

(72) Inventor: Michel Sagardoyburu, Neuchâtel (CH)

(73) Assignee: The Swatch Group Research and Development Ltd, Marin (CH)

(21) Appl. No.: 19/226,763

(22) Filed: Jun. 3, 2025

(30) Foreign Application Priority Data
Aug. 8, 2024 (EP) 24193708.5

(51) Int. Cl. G02F 1/1335; G02F 1/1343; G04G 9/12

(52) U.S. Cl. CPC G02F 1/133528; G02F 1/133553; G02F 1/134309; G04G 9/126; G02F 2202/28

(57) ABSTRACT

A display device including a liquid crystal cell (2) formed from two transparent plates (4, 6) defining a useful zone (12), designed to define the visible zone of the cell in a timepiece, and incorporating electrodes forming a switchable display of an item of information and/or a decoration in the useful zone. The liquid crystal cell (LCD cell) includes, in the useful zone, a plurality of polarisers (16, 18) which are arranged on the outer surface (5) of one of the two transparent plates respectively in a plurality of separate zones (17, 19) and which each partially form the switchable display. At least two polarisers in the plurality of polarisers have a different optical property or a different polarisation direction between them. The device generates visually a variation between respective parts of the two polarisers and/or respective parts of the switchable display in the respective separate zones.

### CROSS REFERENCE TO RELATED APPLICATIONS

This application is claiming priority based on European Patent Application No. 24193708.5 filed on Aug. 8, 2024.

### TECHNICAL FIELD OF THE INVENTION

The present invention relates to the field of manufacturing liquid crystal display devices (hereinafter also referred to as “LCD devices”) for timepieces and more generally liquid crystal cells (hereinafter also referred to as “LCD cells”) forming such LCD devices.

### TECHNOLOGICAL BACKGROUND

Document EP 1 128 240 describes an electronic display assembly with contrast inversion which is formed from a liquid crystal display cell having electrodes and counter-electrodes defining switchable information segments, and from a light valve overlapping the display cell and formed by a liquid crystal cell having an electrode and a counter-electrode covering the entire useful zone of the display cell in order to be able to successively vary the contrast of the entire useful zone of the display cell or at least two electrodes and two corresponding counter-electrodes defining at least two display zones complementary to the useful zone which can, respectively, simultaneously present a positive contrast (dark information on a light background) and a negative contrast (light information on a dark background). The display cell and light valve comprise a first front polariser and a second rear polariser. The term “useful zone” of the display cell or electronic display assembly is understood to mean the zone designed to be seen by a user, in other words, the visible zone of this display cell or electronic display assembly once the electronic display assembly has been incorporated into a timepiece.

Document EP 1 156 360 provides similar teaching to that of the preceding document, but is a little more sophisticated in that it provides a display assembly with chromatic contrast inversion which is designed to be capable of reversing the colour of the information displayed or that of the background on which this information appears when the electrodes of the display cell are activated (ON state). An intermediate polariser located between the display cell and the light valve is also provided for this purpose.

To enable contrast inversion or to differentiate various display zones within the display assembly by varying the colour of the respective backgrounds, the aforementioned display assemblies are complex and cumbersome. They are formed from two liquid crystal cells stacked one on top of each other. It should be noted, however, that being able to differentiate between display zones by the colour (including white and black) of the background and/or the shade, in particular light or dark, of this colour and/or by the colour of the information displayed is useful for highlighting some of the information or for making it stand out. In particular, this provides a visual contrast between different display zones. Thus, the separation of various display zones in LCD display assemblies offers an interesting aesthetic aspect in addition to a functional aspect, for example by visually separating a time display zone from a date display zone or from a chosen function.

### SUMMARY OF THE INVENTION

The primary purpose of the invention is to provide liquid crystal display devices (LCD devices) which comprise an LCD cell for the switchable display of at least one item of information and/or at least one decoration and which define various zones in a useful zone of the LCD cell, at least two of which can be used for the switchable display and between which there is a visual variation, in particular a colour difference (including white and black) or/and a difference in shade (lighter or darker) of at least one colour and/or different optical effects between said at least two zones and/or a colour difference in the switchable display provided in these at least two zones. The invention therefore aims to visually distinguish said at least two zones, in the useful zone of an LCD cell in an LCD display device, and/or the information or a decoration that can be switched in these at least two zones, and to do so whilst taking up little space, in particular without increasing the thickness of conventional LCD cells forming such LCD display devices, and with relatively little complexity.

To this end, the invention provides a horological display device comprising a liquid crystal cell formed from a first plate and a second plate, which are transparent, and a bead of glue joining the first and second plates and defining therewith a closed space containing liquid crystals, the liquid crystal cell defining within the bead of glue a useful zone, which is intended to define the visible zone of that liquid crystal cell in a timepiece for which the display device is designed, and incorporating electrodes (hereinafter including “electrodes” and “counter-electrodes”) forming a switchable display of at least one item of information and/or at least one decoration in the useful zone. The liquid crystal cell comprises a plurality of polarisers in the useful zone, said polarisers being arranged on the outer surface of the first plate in a plurality of separate zones and each partially forming said switchable display. Then, least two polarisers in the plurality of polarisers have at least one different optical property or a different polarisation direction between them, the horological display device being arranged to generate visually a variation between at least respective parts of said at least two polarisers and/or respective parts of said switchable display in the respective separate zones.

The invention has the advantage of achieving the main purpose of the invention using a single LCD cell, with no additional light valve overlapping the LCD cell. In other words, the horological display device according to the invention can comprise only one base assembly, which is formed by two transparent plates joined by a bead of glue and defining between them a space containing liquid crystals. The display therefore takes up very little space; in particular, it does not increase the thickness of LCD display devices used in horology, and is relatively uncomplicated.

In a general embodiment, said at least two polarisers in the plurality of polarisers extend substantially in the same geometric plane.

In a first variant of the general embodiment, said at least two polarisers in the plurality of polarisers are juxtaposed and have respective outlines, of which a part of one runs alongside a part of the other.

In a second variant of the general embodiment, a first polariser of the said at least two polarisers in the plurality of polarisers has an opening in which a second polariser of said at least two polarisers is located, the second polariser having an outer outline running along the outline of the opening.

The general embodiment has the advantage of taking up very little space, as it does not increase the thickness of a conventional LCD cell forming LCD horology display devices.

### BRIEF DESCRIPTION OF THE FIGURES

The invention will be described in greater detail below with reference

to the appended drawings, which are given by way of non-limiting examples, in which:

FIG. 1 is a cross-sectional view along section line I-I in FIG. 2 of an LCD cell forming a first variant of a first main embodiment of a horological display device according to the invention;

FIG. 2 is a top view of the horological display device shown in FIG. 1;

FIG. 3 is a cross-sectional view of an LCD cell forming a second variant of the first main embodiment;

FIG. 4 is a cross-sectional view, along line IV-IV in FIG. 5, of an LCD cell forming a third variant of the first main embodiment;

FIG. 5 is a top view of the horological display device shown in FIG. 4;

FIG. 6 is a cross-sectional view, similar to FIG. 1, of an LCD cell forming a first variant of a second main embodiment of a horological display device according to the invention;

FIG. 7 is a cross-sectional view of an LCD cell forming a second variant of the second main embodiment;

FIG. 8 is a cross-sectional view of an LCD cell forming a third variant of the second main embodiment; and

FIG. 9 is a top view of a particular variant of the horological display device according to the invention.

### DETAILED DESCRIPTION OF THE INVENTION

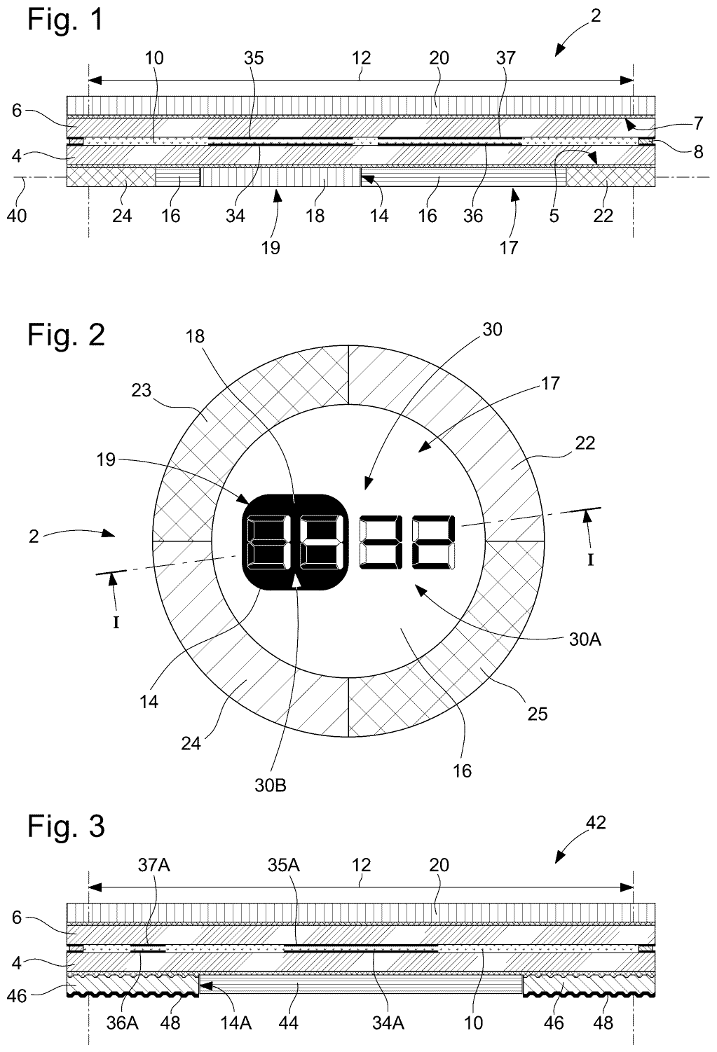

With reference to FIGS. 1 and 2, an LCD cell 2 which forms a first variant of a first main embodiment of a horological display device according to the invention will be described.

The horological display device generally comprises a liquid crystal cell 2 formed from a first transparent plate 4, a second transparent plate 6 and a bead of glue 8 joining the first and second plates and defining with them a closed space containing liquid crystals 10. The liquid crystal cell defines a useful zone 12 within the bead of glue, which is intended to define the visible zone of this cell in a timepiece for which the display device is designed, and it incorporates two sets of electrodes 34 and 36 on the inner surface of the first transparent plate 4 and two sets of electrodes 35 and 37 on the inner surface of the second transparent plate 6 which are situated, respectively, facing the sets of electrodes 34 and 36 and at least partially overlap these electrodes in order to form a switchable display 30 of at least one item of information and/or of at least one decoration in the useful zone. It should be noted that “set of electrodes” is generally understood to mean “at least one electrode” and that the numerical reference refers either to the set of electrodes or to one or more electrode(s) in this set of electrodes. In the example shown in FIG. 2, each set of electrodes comprises a plurality of electrodes defining segments for the conventional display of digits “0” to “9” in an LCD horological display (each set of electrodes is represented in the figures by a continuous line to simplify the drawing).

According to the invention, the liquid crystal cell 2 comprises a plurality of polarisers in the useful zone 12, more specifically two polarisers 16 and 18 in the example shown in the figures, which are arranged on the outer surface 5 of the first plate 4 respectively in a plurality of separate zones, namely two separate zones 17 and 19 in the example shown. Each of the electrodes 34 to 37 overlaps a polariser 16, 18 in the plurality of polarisers and a polariser 20 arranged on the outer surface 7 of the second transparent plate 6 so that together they form the switchable display 30. Moreover, generally speaking, at least two polarisers in the plurality of polarisers (namely, the two polarisers 16, 18 in the variant shown) each overlap at least one pair of electrodes 34 and 35, respectively 36 and 37, arranged to form a part 30A, respectively 30B of the switchable display 30 in the respective separate zone 17, 19 into which this polariser extends. It should be noted that, in the example shown in the figures, each of the two polarisers 16, 18 thus overlaps at least one pair of electrodes to form part of the switchable display 30 in the respective separate zone of this polariser. In other words, each of the polarisers in said plurality of polarisers forms part of the switchable display 30.

Then, generally speaking, said at least two polarisers in the plurality of polarisers have at least one different optical property or a different polarisation direction between them, and the LCD cell is arranged so as to visually generate, in the horological display device, a variation between at least respective parts of said at least two polarisers and/or respective parts of the switchable display in said at least two respective separate zones. In the example shown, the two polarisers 16 and 18 have a visual variation between them in the display device, more particularly in the LCD cell 2, namely in combination with the polariser 20 arranged opposite on the outer surface of the second plate 6. Furthermore, the parts 30A and 30B of the switchable display 30 in the respective separate zones 17 and 19 also visually display a variation when these parts of the switchable display are activated.

In the first variant shown in FIGS. 1 and 2, the polarisers 16 and 18 are preferably rear polarisers, arranged under the plate 4, which is a bottom plate, and the polariser 20 is a front polariser which is advantageously the only polariser arranged on the outer surface 7 of the second plate 6, which is an upper plate. Preferably, as shown, the single polariser 20 extends over the entire useful surface 12 of the LCD cell 2 and advantageously slightly around the periphery of this useful surface. It should be noted that in a particular variant, the LCD cell 2 is inverted for its arrangement in a watch such that polarisers 16 and 18 are then front polarisers and polariser 20 is a rear polariser. This particular variant is not preferred, given that a one-piece front polariser extending over the entire useful surface 12 is aesthetically advantageous, since the interstices between rear polarisers are less visible to a user of the watch than the same interstices between front polarisers.

Then, specifically, the three polarisers 16, 18 and 20 are materially identical and are of the absorbent-transmissive type. The LCD display device is arranged in a watch above a clear dial with a different colour to that of the polarisers, in particular above an analogue display which can be seen at least partially through the LCD display device. However, polariser 16 has a polarisation direction in the LCD cell 2 that is orthogonal to that of polarisers 18 and 20, the latter having the same polarisation direction. As the LCD cell in this case is of the TN type, the separate zone 17 will have a relatively light background (depending on the colour of the dial) and the part 30A of the analogue display will have a positive contrast, with the pairs of overlapping and activated electrodes generating relatively dark segments. On the other hand, the separate zone 19 will have a relatively dark background and the part 30B of the analogue display will have a negative contrast, with the pairs of overlapping and activated electrodes generating relatively light segments (depending on the colour of the dial). In this way, the zone 17 in the useful zone 12 makes it possible to see what is below it at all times through the LCD display device, in particular an analogue display and a dial, with only the activated segments of the switchable display masking this background. In contrast, the zone 19 in the useful zone 12 only allows this background to be seen through the activated segments of the switchable display. It should be noted that, to increase the contrast, the polariser 18 is advantageously covered on its rear surface by a reflective film, as will be the case in other variants which will be described hereinafter. In another arrangement of the watch, the LCD cell is arranged as the dial of an analogue display, namely under the hands of this analogue display. Although the arrangement of the LCD display device according to the invention is advantageously incorporated into a watch with an analogue display, the display device according to the invention can also be incorporated into an electronic watch which does not have an analogue display.

In a first general variant, said different optical property between two polarisers is a colour variation.

In a second general variant, said different optical property between two polarisers is a variation in shade in a given colour; namely a variation in intensity.

According to an important feature of the main embodiments, said at least two polarisers of the plurality of polarisers extend substantially in the same geometric plane, preferably in the same geometric plane 40. More generally, all of the polarisers in said plurality of polarisers extend substantially in the same geometric plane, preferably all in the same geometric plane 40.

According to a particular feature of the invention, a first polariser of said at least two polarisers in the plurality of polarisers has an opening in which a second polariser of said at least two polarisers in the plurality of polarisers is located, the second polariser having an outer outline running along the outline of the opening. In the first variant described in this case, the polariser 16 has an opening 14 in which the polariser 18 is located, the dimensions of which correspond to those of the opening. The outer outline of the polariser 18 thus runs along the outline of the opening 14. The term “longer” is understood to have a standard dictionary definition, namely “to run along and close to, in particular parallel to.” The interstice between the two outlines which run alongside each other is intended to be minimal, almost invisible or preferably invisible to a user. In the main embodiments, as the first and second polarisers are arranged substantially in the same geometric plane and preferably in the same geometric plane, the polariser 18 is located inside the opening 14 of the polariser 16. To ensure that the interstice is minimal and preferably invisible, a specific manufacturing method is required to position the polariser 16 very precisely relative to the polariser 18. To this end, targets/guide marks can be provided on at least one of the two transparent plates 4 and 6, such as the ones shown in FIG. 1 above and below the bead of glue 8, which are outside the useful zone 12. These targets/guide marks enable precise alignment with alignment marks in a fixed and determined relationship with a polariser when it is deposited on the outer surface of the transparent plate on which it is ultimately arranged.

In the embodiment shown in FIGS. 1 and 2, four decorative annular parts 22, 23, 24 and 25 are also provided, and are arranged around the periphery of the polariser 16 on the outer surface 5 of the bottom plate 4, this polariser 16 having a circular outer outline. These decorative parts are arranged in the same geometric plane as the polarisers 16 and 18 (it should be noted that these polarisers and the decorative annular parts are shown in FIG. 2, in a transparent view relative to the elements located above them). Each decorative annular part has an inner radius substantially equal to the radius of the polariser 16. It is also provided that the inner outlines of the decorative parts run along the outer outline of the polariser 16, so that the interstice between these elements is also minimal and preferably invisible to a user. These decorative parts may vary. In a first example, these are portions of coloured opaque film. In a second example, these are colour filters that allow a certain amount of light to pass through, making it possible to see or distinguish elements located underneath. It should be noted that, in a first variant, the decorative parts are not polarisers, as no switchable display is provided in the respective zones of these decorative parts. However, particularly for aesthetic reasons and to prevent the rim of the upper/front polariser 20 from being visible, this upper/front polariser also covers the decorative parts 22 to 25, since it extends over the entire useful surface 12 of the LCD cell 2. In a second variant, the decorative parts can be formed by polarisers. However, no electrodes are provided facing these polarisers, such that they have a purely decorative function. Conventionally, the polarisers and decorative parts are glued to the corresponding transparent plate.

FIG. 3 shows a second variant of the first main embodiment. Not all elements similar to the first variant will be described again. The liquid crystal cell 42 comprises a first transparent plate 4, which is a bottom plate of the LCD cell 42. Two polarisers 44 and 46 are arranged under this plate 4, polariser 46 having an opening 14A in which polariser 44 is located. Similar to the first variant, the outline/rim of the polariser 44 runs along the outline/rim of the opening 14A. This second variant differs from the first in that the rear surface of polariser 46 is covered by a reflective film 48. Moreover, the second variant is distinguished from the first variant by the fact that the assembly formed by the polariser 46 and the reflective film 48 has a relief which visually generates a pattern, periodic or otherwise, which is visible to a user of the watch in which the LCD cell 42 is incorporated.

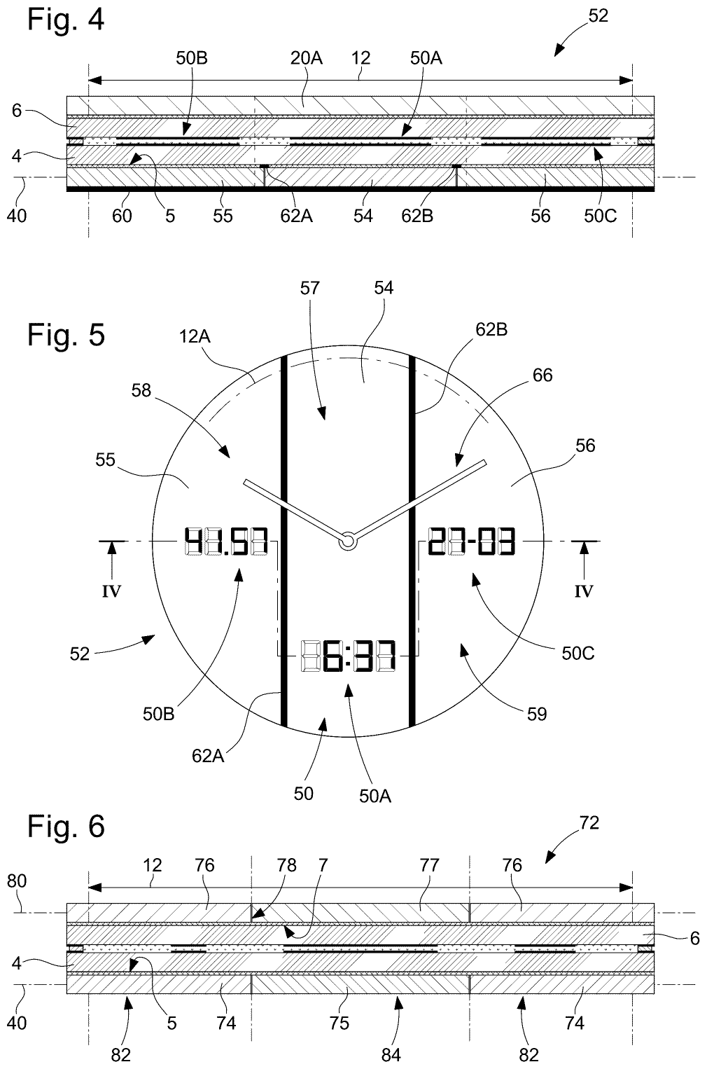

With reference to FIGS. 4 and 5, a description will be given of an LCD cell 52 which forms a third variant of the first main embodiment of a horological display device according to the invention. References already described will not be described again here.

In the third variant, at least two polarisers are generally provided side by side, these two polarisers having respective outlines, of which a part of one runs alongside a part of the other.

The expression “two juxtaposed polarisers” is understood to mean that the two polarisers have outlines/rims with a part of the outline/rim of the first polariser running alongside a part of the outline/rim of the other polariser. “Run alongside” indicates that said part of the outline/rim of the one polariser closely follows said part of the outline/rim of the other polariser, preferably substantially parallel. These two respective parts of the two outlines/rims can have an interstice (small slit) between them, preferably hardly perceptible or imperceptible to a user of the display device according to the invention. In a particular variant, the outlines/rims, in the useful zone 12, of juxtaposed polarisers are covered by a narrow masking strip, as will be explained hereinafter.

In the third variant, as shown, the LCD cell 52 comprises a front polariser 20A, in particular an absorber-transmissive polariser, and three juxtaposed rear polarisers 54, 55 and 56 arranged in the same geometric plane 40. Whenever two or more polarisers are juxtaposed, this is understood to mean that each polariser is juxtaposed with at least one other polariser. Thus, in the variant shown, the polarisers 54 and 55 are juxtaposed, two rectilinear parts of their respective outlines being parallel and in close proximity, or even practically merging (the rims defining these two rectilinear parts may be almost touching each other). The same is true for polarizers 55 and 56. Here again, the front polariser 20A extends throughout the useful zone 12 and, in this useful zone, completely covers the rear polarisers 54, 55 and 56. The LCD cell 52 is used to form the dial of a watch with an analogue display 66. The LCD cell 52 forms a disc pierced at its centre for the passage of the axes of the hands of the analogue display and the useful zone 12 corresponds to the part of the dial visible to a user of the watch in which the display device comprising the LCD cell 52 is incorporated. The useful surface is therefore an annular zone, with an outer limit 12A corresponding to the circle defined by a watchcase flange on the LCD cell. The switchable display 50 comprises three particular displays 50A, 50B and 50C which are, respectively, formed by the three polarisers 54, 55 and 56 in the plurality of polarisers arranged on the outer surface 5 of the transparent plate 4 and located in three separate zones 57, 58 and 59, respectively, of the useful zone 12. In the example given, the switchable display 50A is a display of the hours and minutes of a time interval measured in a stopwatch mode and the switchable display 50B gives the seconds and hundredths of a second of this measured time. The display 50C shows the date and month.

A reflective film 60 is arranged under the three polarisers 54 to 56 and covers these three polarisers. The reflective film 60 is in one piece and is glued to the three polarisers in a step subsequent to gluing the polarisers to the outer surface 5 of the plate 4.

Advantageously, the polariser 54 has a different colour from the two polarisers 55 and 56. In one variant, the rear polarisers have various colours. A given colour can also have different shades. Generally speaking, each polariser in the plurality of polarisers can be formed by a single polarising film or several polarising films. In other words, each polariser is formed by at least one polarising film. Each polariser can be combined with a colour filter and/or a lower reflective and/or opaque film. In one variant, the lower surface of each polariser is covered by its own reflective film which has the same dimensions as the polariser, each polariser being assembled with its own reflective film before being deposited on the transparent plate 4. It should be noted that coloured filters can extend over or under the polarisers, individually or together over/under at least two of the polarisers, in particular over/under all of the polarisers in the plurality of polarisers. It is understood that the possible combinations available to the person skilled in the art are numerous and make it possible to obtain various decorative variations with differently-coloured visual effects for the background of the LCD cell and also for the elements of the switchable display.

The third variant also has a special feature which can also be provided in other variants of the first embodiment, in particular in the first and second variants described above, and also in variants of the second embodiment which will be described hereinafter. This feature consists in masking, in the useful zone, the rims of polarisers in the plurality of polarisers, in particular when two polarisers are juxtaposed (first case) or when one polariser is located inside an opening in another polariser (second case), by an opaque material which covers these rims and thereby the outlines of these polarisers in such a way as to mask, for a user of the timepiece for which the display device is designed, any possible interstice between two respective parts of two of these outlines, one of which runs alongside the other (in the first case), or between two of these outlines, one of which runs alongside the other (in the second case). In the variant shown in FIGS. 4 and 5, the opaque material forms two straight masking strips 62A and 62B. In this variant, the transparent plate 4 is a bottom plate of the LCD cell 52 and the plurality of polarisers 54 to 56, which are arranged on its outer surface, are rear polarisers (it should be noted that these polarisers and the masking strips are shown, in FIG. 5, in a transparent view relative to the elements situated above). In this case, the opaque material is advantageously deposited on the outer surface 5 of the plate 4 between the latter and the outlines of the polarisers, the outlines of which are covered by the opaque material in the useful zone 12.

With reference to FIG. 6, a description will be given of an LCD cell 72 forming a first variant of a second main embodiment of a horological display device according to the invention. The elements already described in the first embodiment will not be described again here in detail.

In the useful zone 12, as in the first embodiment, the LCD cell 72 comprises a first plurality of polarisers, 74 and 75, arranged on the outer surface 5 of the first transparent plate 4 and extending in the geometric plane 40. According to a general feature of the second embodiment, in the useful zone 12 the LCD cell 72 further comprises a second plurality of polarisers, 76 and 77, which are arranged on the outer surface 7 of the second transparent plate 6 respectively in a second plurality of separate zones, 82 and 84. Generally speaking, at least two polarisers 76 and 77 in the second plurality of polarisers have at least one different optical property or polarisation direction between them. It should be noted that the switchable display zones are shown as in the first embodiment, but with no references.

According to an advantageous feature, the second plurality of polarisers extends substantially in the same geometric plane, preferably in the same geometric plane 80 as in the example shown.

The first variant described here has two specific features. First, the first polariser 76 in the second plurality of polarisers has an opening 78 in which the second polariser 77 in this second plurality of polarisers is located, this second polariser having an outer outline which runs along the outline of the opening. According to the second specific feature, which is independent of the first, the two polarisers 74, 75 in the first plurality of polarisers respectively overlap the two polarisers 76, 77 in the second plurality of polarisers and extend into the same respective separate zones 82 and 84 in the useful zone 12. The polariser 74 thus has an opening with an outline which is aligned, in a direction orthogonal to the general plane of the LCD cell (parallel to the geometric planes 40 and 80), with the outline of the opening 78 of the polariser 76. Zone 82 in the useful zone 12 of LCD cell 72 is therefore independent, both in terms of the background and the switchable display, from zone 84 in this useful zone.

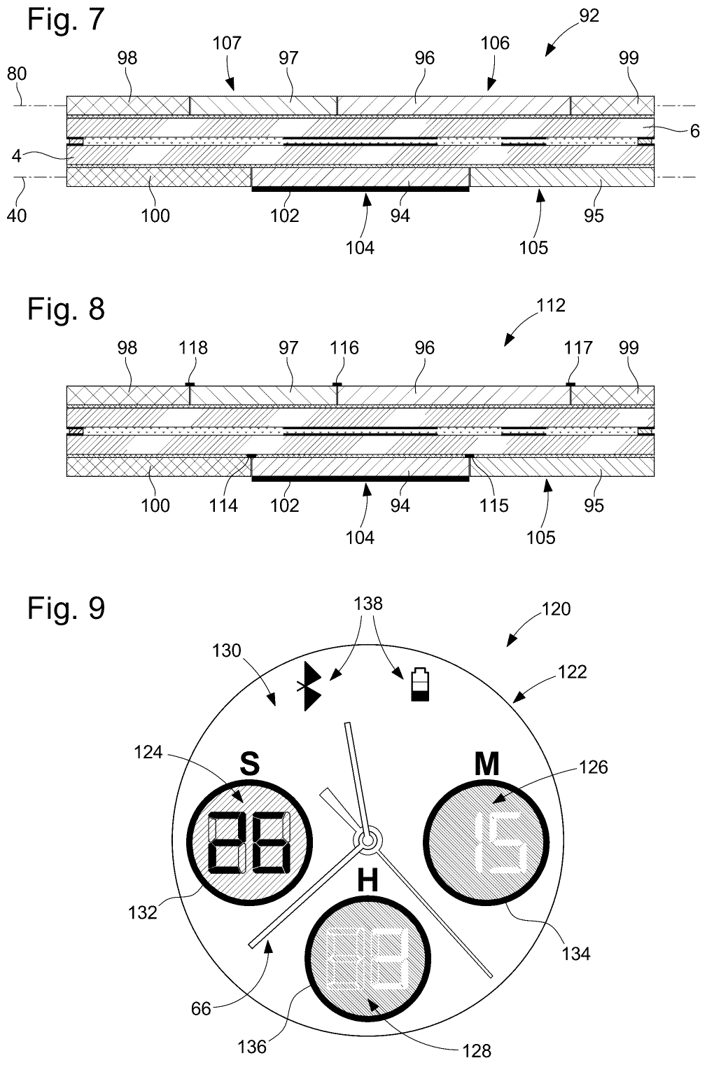

With reference to FIG. 7, a description will be given of a second variant of the second embodiment which makes it possible to obtain an LCD display device with numerous zones that vary visually for a user and together form a relatively complex pattern that makes it possible to define an original decoration.

The LCD cell 92 comprises a first plurality of polarisers, each of which partially defines the switchable display, namely polarisers 94 and 95, which are arranged on the outer surface of the plate 4, which in the example shown is a smaller plate, and a second plurality of polarisers, each of which also partially defines the switchable display, namely polarisers 96 and 97, which are arranged on the outer surface of the plate 6. The first plurality of polarisers extends in geometric plane 40 and the second plurality of polarisers extends in geometric plane 80.

The second variant has two specific features. First, at least two polarisers 96, 97 in the second plurality of polarisers are juxtaposed, these two polarisers having respective outlines, of which a part of one runs alongside a part of the other. Similarly, the two polarisers 94, 95 in the first plurality are also juxtaposed. As a second specific feature, at least one first polariser from the first plurality of polarisers only partially overlaps at least one second polariser from the second plurality. More specifically, in the variant shown, polariser 94 partially overlaps polariser 96 and partially overlaps polariser 97, and polariser 95 partially overlaps polariser 96. Thus, in the useful zone, the outlines of the polarisers in the first plurality are not aligned with the outlines of the polarisers in the second plurality, such that the respective separate zones 104 and 105 of polarisers 94 and 95 are not superimposed on the respective separate zones 106 and 107 of polarisers 96 and 97. As a result, this configuration means that the separate zones in the geometric plane 40, relative to the arrangement of the first plurality of polarisers, and the separate zones in the geometric plane 80, relative to the arrangement of the second plurality of polarisers, give rise to more visually varied zones than the number of polarisers in the first plurality and the number of polarisers in the second plurality.

In the variant shown, a reflective film 102 is arranged only under the polariser 94, which is a rear polariser.

The LCD cell 92 also comprises, in a separate zone of the lower geometric plane 40, a decorative film 100 which is juxtaposed with the polariser 94 and, in two respective separate zones of the upper geometric plane 80, two decorative films 98, 99 which are respectively juxtaposed with the polarisers 96, 97. Dans une alternative, un seul film décoratif est prévu dans le plan géométrique supérieur 80, ce film décoratif présentant une ouverture dans laquelle sont situés les polariseurs 96 et 97 qui remplissent ensemble cette ouverture. Decorative films are formed by colour filters, polarisers or other films which may be opaque or reflective and flat or raised. These decorative films do not contribute to the switchable display of the LCD cell 92, but they do contribute to the visual appearance of the LCD cell in the useful zone 12 and visually differentiate various zones in this useful zone to define a composition of decorative zones.

FIG. 8 shows a third variant of the second main embodiment of the invention. This third variant differs from the second variant by masking, in the useful zone, the rims of polarisers 94 and 95 and decorative film 100 which extend into the lower geometric plane and therefore the outlines of these elements, each of which runs alongside the other. The LCD cell 112 comprises masking strips 114 and 115 which are formed by an opaque material as in the third variant of the first embodiment. Then, this third variant differs from the second variant by masking, in the useful zone, the rims of polarisers 96 and 97 and decorative films 98 and 99 which extend into the upper geometric plane and which are juxtaposed, the outlines of these elements each running at least partially alongside another in the useful zone. To this end, the LCD cell 112 comprises masking strips 116, 117 and 118 which are formed by an opaque material deposited above said rims.

Generally speaking, the masking strips are formed by an opaque material which covers the outlines of the polarisers in the second plurality of polarisers so as to mask, for a user of the timepiece for which the display device is designed, any possible interstice between two respective parts of two of these outlines, one of which runs alongside the other, or between two of these outlines, one of which runs alongside the other. In the example shown, given that, in addition to the polarisers in said second plurality, there are decorative films arranged in the same upper geometric plane 80, the opaque material also covers the outlines of these decorative films in the useful zone.

FIG. 9 is a top view of a dial 120 formed by a display device according to the invention and comprising a liquid crystal cell 122. This LCD cell 122 is made in a similar way to the one described in connection with the first variant of the first embodiment or of the second embodiment, with, in addition, the arrangement of the masking strips 132, 134 and 136 made as described in the third variant of the first embodiment or of the second embodiment. A plurality of polarisers are arranged in the respective separate zones 124, 126, 128 and 130. At least one of the polarisers arranged in zone 130 has three openings in which are arranged three polarisers each with at least one different optical property or polarisation direction with the polariser having the three openings. The dial 120 is fitted to a watch with an analogue display 66 showing the hour, minute and second of the current time. The switchable display of the LCD cell 122 is configured so that it can be used for a stopwatch function of the watch. The second, minute and hour of a timed interval are thus respectively displayed in separate circular zones 124, 126 and 128. In the separate zone 130, symbols 138 may be displayed relating to at least one function of the watch, for example activation of the “Bluetooth” function, or the battery level. The letters “S,” “M” and “H” can also be part of the switchable display and only appear when the stopwatch function is activated. This configuration is particularly advantageous when the switchable display in zones 124, 126 and 128 is desired for other information as well. In an alternative dedicated to the stopwatch function alone, these letters can be obtained by using ink deposited on the dial or possibly in the LCD cell. In the example shown, the zone 124 has a visual variation relative to zones 126 and 128; this variation can be a different colour or a different shade in a given colour, including grey. The switchable display part in the zone 124 is of the positive contrast type, whilst the switchable display parts in the zones 126 and 128 are of the negative contrast type.

1. A horological display device comprising a liquid crystal cell formed from a first plate and a second plate, which are transparent, and from a bead of glue joining the first and second plates and defining therewith a closed space containing liquid crystals, the liquid crystal cell defining within the bead of glue a useful zone, which is intended to define the visible zone of this cell in a timepiece for which the display device is designed, and incorporating electrodes forming a switchable display of at least one item of information and/or at least one decoration in the useful zone;
wherein the liquid crystal cell comprises, in the useful zone, a plurality of polarisers which are arranged on the outer surface of the first plate respectively in a plurality of separate zones and which each form in part said switchable display; and
wherein at least two polarisers in the plurality of polarisers have between them at least one different optical property or a different polarisation direction, the horological display being arranged so as to visually generate a variation between at least respective parts of the at least two polarisers and/or respective parts of said switchable display in the respective separate zones.

2. The display device according to claim 1, wherein said plurality of polarisers extends substantially in a same geometric plane.

3. The display device according to claim 2, wherein said at least two polarisers in the plurality of polarisers are juxtaposed, these two polarisers having respective outlines, of which at least a part of one runs alongside at least a part of the other.

4. The display device according to claim 3, wherein a first polariser of said at least two polarisers in the plurality of polarisers has an opening in which a second polariser of said at least two polarisers in the plurality of polarisers is located, the second polariser having an outer outline running along the outline of the opening.

5. The display device according to claim 3, wherein an opaque material covers the polariser outlines of said plurality of polarisers so as to mask, for a user of the timepiece for which the display device is designed, any possible interstice between two respective parts of two of said outlines, one part of which runs alongside the other part, or between two of said outlines, one of which runs alongside the other.

6. The display device according to claim 5, wherein the first plate is a bottom plate of the liquid crystal cell, the polarisers of said plurality of polarisers being rear polarisers of the liquid crystal cell.

7. The display device according to claim 6, wherein the opaque material is deposited on the outer surface of the first plate between the plate and the rims of said polarisers, the outlines of which are covered by the opaque material.

8. The display device according to claim 1, wherein a single polariser is arranged on the outer surface of the second plate, the second plate being an upper plate and the single polariser being a front polariser of the liquid crystal cell.

9. The display device according to claim 8, wherein said single polariser extends over the entire said useful surface of the liquid crystal cell.

10. The display device according to claim 1, in which said plurality of polarisers is a first plurality of polarisers and said plurality of separate zones is a first plurality of separate zones; wherein the liquid crystal cell comprises in said useful zone a second plurality of polarisers which are arranged on the outer surface of the second plate, respectively in a second plurality of separate zones; and wherein at least two polarisers in the second plurality of polarisers have between them at least one different optical property or a different polarisation direction.

11. The display device according to claim 10, wherein the second plurality of polarisers extends substantially in the same geometric plane and at least two polarisers in the second plurality of polarisers are juxtaposed, these two polarisers having respective outlines of which at least a part of one runs alongside at least a part of the other.

12. The display device according to claim 11, wherein the second plurality of polarisers extends substantially in the same geometric plane; and wherein a first polariser in the second plurality of polarisers has an opening in which a second polariser in the second plurality of polarisers is located, said second polariser having an outer outline running along the outline of the opening.

13. The display device according to claim 11, wherein an opaque material covers the polariser outlines of the second plurality of polarisers so as to mask, for a user of the timepiece for which the display device is designed, any possible interstice between two respective parts of two of said outlines, one part of which runs alongside the other part, or between two of said outlines, one of which runs alongside the other.

14. The display device according to claim 1, wherein said different optical property between two polarisers is a colour variation.

15. The display device according to claim 10, wherein said different optical property between two polarisers in the second plurality of polarisers is a colour variation.

16. The display device according to claim 1, wherein said different optical property between two polarisers is a variation in shade.

17. The display device according to claim 10, wherein said different optical property between two polarisers in the second plurality of polarisers is a variation in shade.

18. The display device according to claim 1, wherein the first plate is a bottom plate of the liquid crystal cell; and wherein at least one of the polarisers in the plurality of polarisers is covered on its rear surface by a reflective film.
